(19) United States
(12) Patent Application Publication
(10) Pub. No.: US 2026/0307614 A1
(43) Pub. Date: Oct. 8, 2026

(54) PEDESTRIAN PROTECTION DEVICE

(71) Applicant: SUBARU CORPORATION, Tokyo (JP)

(72) Inventors: Ryosuke NAMBA, Tokyo (JP); Yasushi TAKASO, Tokyo (JP); Toshiharu YASUI, Tokyo (JP); Takumi AKABANE, Tokyo (JP); Yusuke KANO, Tokyo (JP); Tetsuya YOSHIDA, Tokyo (JP); Daiki KOIKE, Tokyo (JP); Aito KANNO, Tokyo (JP)

(21) Appl. No.: 19/575,628

(22) Filed: Mar. 23, 2026

(30) Foreign Application Priority Data
Apr. 2, 2025 (JP) 2025-061413

(51) Int. Cl. B60R 21/36; B60R 19/48; B60R 21/0132; B60R 21/0134; B60R 21/0136; G01L 23/00; G01S 17/89; G01S 17/931; G06V 10/12; G06V 20/58; G06V 20/64; G06V 40/10

(52) U.S. Cl. CPC B60R 21/36; B60R 21/0132; B60R 21/0134; B60R 21/0136; G01L 23/00; G01S 17/89; G01S 17/931; G06V 10/12; G06V 20/58; G06V 20/64; G06V 40/10; B60R 19/48

(57) ABSTRACT

A pedestrian protection device for a vehicle includes a surrounding environment, a vehicle speed sensor, a collision detection sensor, a pedestrian protection mechanism, and a control unit. The control unit calculates, based on outputs of the surrounding environment recognition device and the vehicle speed sensor, a time to collision for a recognized pedestrian, and, when the time to collision is within a predetermined number of seconds and the pedestrian is recognized before the collision input to the collision detection sensor is detected, determines that the vehicle has collided with the recognized pedestrian even in a case where a vehicle speed value detected by the vehicle speed sensor is within a predetermined range of pedestrian collision determination vehicle speed values, and a detection value obtained by the collision detection sensor does not exceed a predetermined threshold.

### CROSS-REFERENCE TO RELATED APPLICATIONS

The present application claims priority from Japanese Patent Application No. 2025-061413 filed on Apr. 2, 2025, the entire contents of which are hereby incorporated by reference.

### BACKGROUND

The disclosure relates to a pedestrian protection device for a vehicle such as an automobile, for protecting a pedestrian or the like by operating a pedestrian protection mechanism in response to a collision input to a collision detection sensor.

Various pedestrian protection devices of the related art have been proposed in, for example, Japanese Unexamined Patent Application Publication No. 2019-217877, Japanese Unexamined Patent Application Publication No. 2007-296941, Japanese Unexamined Patent Application Publication No. 2004-17812, and the like and put into practical use for, in response to detection of an input equal to or greater than a predetermined threshold to a collision detection sensor mounted in a front bumper or the like of a vehicle such as an automobile, determining that the vehicle has collided with a pedestrian or the like, activating a pedestrian protection mechanism (such as a pedestrian protection airbag), and protecting the pedestrian or the like.

### SUMMARY

An aspect of the disclosure provides a pedestrian protection device for a vehicle. The pedestrian protection device is configured to operate a pedestrian protection mechanism in response to a collision input to a collision detection sensor. The pedestrian protection device includes a surrounding environment recognition device, a vehicle speed sensor, the collision detection sensor, the pedestrian protection mechanism, and a control unit. The surrounding environment recognition device is configured to acquire surrounding environment information of the vehicle. The vehicle speed sensor is configured to detect a speed of the vehicle. The collision detection sensor is configured to detect a collision between the vehicle and a three-dimensional object present around the vehicle. The pedestrian protection mechanism includes a pedestrian protection airbag and an inflator. The control unit includes a pedestrian collision determiner and an airbag activation instruction unit. The pedestrian collision determiner is configured to perform a determination on whether a collision of a pedestrian with the vehicle has occurred, based on an output of the surrounding environment recognition device, an output of the vehicle speed sensor, and an output of the collision detection sensor. The airbag activation instruction unit is configured to output an instruction signal for activating the pedestrian protection mechanism based on the determination of the pedestrian collision determiner. The control unit is configured to calculate, based on the output of the surrounding environment recognition device and the output of the vehicle speed sensor, a time to collision for a recognized pedestrian. When the time to collision for the recognized pedestrian is within a predetermined number of seconds and the recognized pedestrian is recognized before the collision input to the collision detection sensor is detected, the pedestrian collision determiner is configured to determine that the vehicle has collided with the recognized pedestrian even in a case where a vehicle speed value detected by the vehicle speed sensor is within a predetermined range of pedestrian collision determination vehicle speed values and a detection value obtained by the collision detection sensor does not exceed a predetermined threshold.

An aspect of the disclosure provides a pedestrian protection device a vehicle. The pedestrian protection device is configured to operate a pedestrian protection mechanism in response to a collision input to a collision detection sensor. The pedestrian protection device includes a surrounding environment recognition device, a vehicle speed sensor, the collision detection sensor, the pedestrian protection mechanism, and circuitry. The surrounding environment recognition device includes a camera and is configured to acquire surrounding environment information of the vehicle. The vehicle speed sensor is configured to detect a speed of the vehicle. The collision detection sensor is configured to detect a collision between the vehicle and a three-dimensional object present around the vehicle. The pedestrian protection mechanism includes a pedestrian protection airbag and an inflator. The circuitry is configured to perform a determination on whether a collision of a pedestrian with the vehicle has occurred, based on an output of the surrounding environment recognition device, an output of the vehicle speed sensor, and an output of the collision detection sensor. The circuitry is configured to output an instruction signal for activating the pedestrian protection mechanism based on the determination. The circuitry is configured to calculate, based on the output of the surrounding environment recognition device and the output of the vehicle speed sensor, a time to collision for a recognized pedestrian. When the time to collision for the recognized pedestrian is within a predetermined number of seconds and the recognized pedestrian is recognized before the collision input to the collision detection sensor is detected, the circuitry is configured to determine that the vehicle has collided with the recognized pedestrian even in a case where a vehicle speed value detected by the vehicle speed sensor is within a predetermined range of pedestrian collision determination vehicle speed values and a detection value obtained by the collision detection sensor does not exceed a predetermined threshold.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a block diagram illustrating a schematic configuration of a vehicle control device including a pedestrian protection device according to an embodiment of the disclosure; and

FIG. 2 is a flowchart illustrating an operation of the vehicle control device including the pedestrian protection device according to the embodiment of the disclosure.

### DETAILED DESCRIPTION

In a conventional pedestrian protection device disclosed in the publications described above and the like, input data to the collision detection sensor may vary, for example, depending on the body size of a pedestrian or the like as a target for collision and the posture of the pedestrian or the like at the time of collision or depending on the traveling state of the vehicle at the time of collision.

In such a case, it may be difficult for the pedestrian protection device to reliably make a collision determination of a pedestrian or the like. The difficulty in reliably making such a collision determination may lead to a failure of ensuring reliable operation of the pedestrian protection mechanism.

It is desirable to provide a pedestrian protection device capable of ensuring reliable operation of a pedestrian protection mechanism to protect a pedestrian or the like more reliably, or capable of reducing collision damage to a pedestrian or the like.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

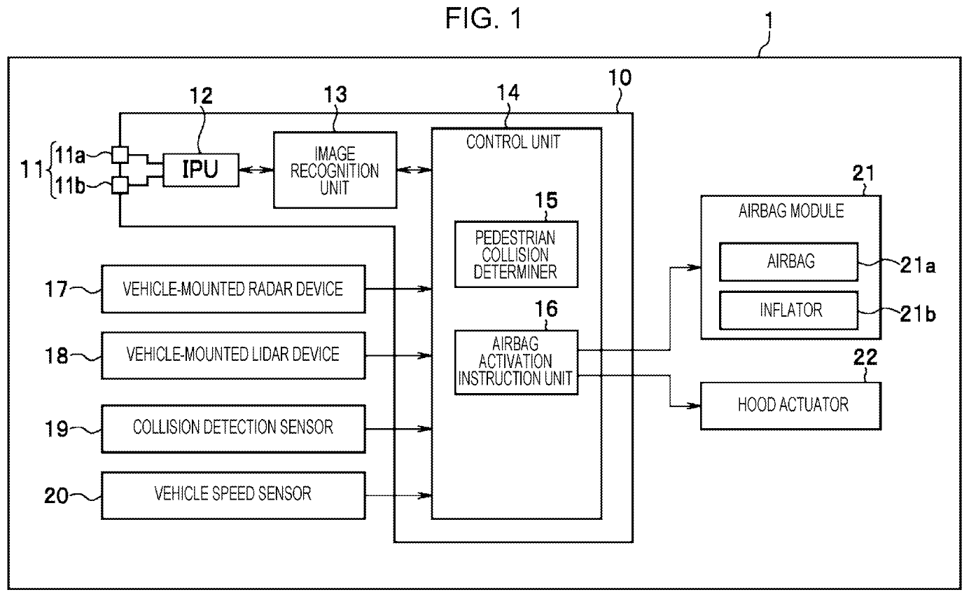

First, a schematic configuration of a vehicle control device including a pedestrian protection device according to the embodiment of the disclosure will be briefly described hereinafter with reference to FIG. 1. FIG. 1 is a block diagram illustrating a schematic configuration of a vehicle control device including a pedestrian protection device according to the embodiment of the disclosure.

The configuration of the vehicle control device including the pedestrian protection device of the present embodiment is basically substantially the same as that of a conventional vehicle control device of the same type. As illustrated in FIG. 1, a vehicle control device 1 includes, as components related to the pedestrian protection device of the present embodiment, a camera unit 10, various sensors (a vehicle-mounted radar device 17, a vehicle-mounted light detection and ranging (LiDAR) device 18, a collision detection sensor 19, a vehicle speed sensor 20, and the like, as described in detail below), and various configuration units (an airbag module 21, a hood actuator 22, and the like, as described in detail below).

The camera unit 10 is a vehicle-mounted camera device fixed to an upper central portion near the front of a vehicle cabin of a vehicle (hereinafter referred to as a “host vehicle” or simply as the “vehicle”; not illustrated) provided with the vehicle control device 1. In this case, the camera unit 10 is disposed inside the windshield of the vehicle.

The camera unit 10 includes, for example, a stereo camera 11, an image processing unit (hereinafter abbreviated as “IPU”) 12, an image recognition unit 13, and a control unit 14.

The stereo camera 11 is a stereo camera unit including two cameras, namely, a main camera 11a and a sub camera 11b. The main camera 11a and the sub camera 11b are disposed, for example, in the vehicle cabin of the host vehicle at positions symmetrical left and right with respect to a center in a vehicle width direction, toward the front (traveling direction) of the host vehicle. Each of the main camera 11a and the sub camera 11b includes, for example, an imaging optical system, an imaging element such as a complementary metal-oxide semiconductor (CMOS) image sensor, and a processing circuit for processing an imaging signal or the like.

With this configuration, the main camera 11a and the sub camera 11b of the stereo camera 11 acquire two pieces of image data from two different viewpoints of a surrounding environment in a predetermined range ahead of the vehicle and outside the vehicle, at predetermined imaging cycles synchronized with each other. The two pieces of image data acquired in this way are used to generate stereo image data. The stereo image data is surrounding environment information representing a surrounding environment during traveling of the host vehicle. The surrounding environment information (image data) generated by the stereo camera 11 is output to the IPU 12.

The IPU 12 is a circuit unit that performs predetermined image processing on the surrounding environment information (image data) acquired by the stereo camera 11. The IPU 12 performs, for example, processing of detecting edges of various objects represented on an image (for example, three-dimensional objects around the vehicle and markings on a road surface (dividing lines or boundary lines marked on an on-premises road surface such as a parking lot; hereinafter referred to as “dividing lines and the like”)). This edge detection processing allows the IPU 12 to recognize three-dimensional objects around the vehicle and dividing lines and the like.

Further, the IPU 12 acquires distance information using an amount of positional deviation between corresponding edges on left and right images based on the stereo image data, and generates image information (distance image information) including the distance information. The distance image information or the like generated by the IPU 12 is output to the image recognition unit 13.

The image recognition unit 13 calculates, based on the distance image information or the like input from the IPU 12, the road curvature (1/m) of left and right dividing lines or the like on a traveling road on which the host vehicle travels (host-vehicle traveling road), the width (lane width) between the left and right dividing lines, and the like. The road curvature and the lane width can be obtained using various known methods.

The image recognition unit 13 performs predetermined pattern matching or the like on the distance image information, and recognizes three-dimensional objects such as guardrails and curbstones extending along a road, nearby other vehicles, pedestrians, bicycles, or specified small motorized bicycles (hereinafter referred to as “pedestrians and the like” or individually as a “pedestrian or the like”).

When recognizing a three-dimensional object, the image recognition unit 13 recognizes, for example, the type of the three-dimensional object, the height of the three-dimensional object, the width dimension of the three-dimensional object, the distance to the three-dimensional object, the speed of the three-dimensional object, the relative speed between the three-dimensional object and the host vehicle, and the relative distance between three-dimensional objects (for example, the lateral distance between a curbstone or the like at a road edge and a nearby dividing line or the like).

The various kinds of information recognized by the image recognition unit 13 are output to the control unit 14 as surrounding environment information. In this case, the camera unit 10 serves as a surrounding environment recognition device that recognizes a surrounding environment (such as pedestrians) around the vehicle.

The control unit 14 is a configuration unit or circuit unit that controls the overall operation of the vehicle control device 1 and controls the pedestrian protection device of the present embodiment. The control unit 14 includes, for example, a pedestrian collision determiner 15, an airbag activation instruction unit 16, and the like.

The pedestrian collision determiner 15 is a configuration unit or circuit unit that determines whether a collision of a pedestrian or the like with the host vehicle has occurred, based on outputs of the various sensors, namely, the collision detection sensor 19 and the vehicle speed sensor 20.

The airbag activation instruction unit 16 is a configuration unit or circuit unit that outputs an appropriate predetermined instruction signal to the airbag module 21 and the hood actuator 22 in response to a determination result by the pedestrian collision determiner 15.

That is, when the determination result of the pedestrian collision determiner 15 indicates that a collision with a pedestrian or the like has occurred, the airbag activation instruction unit 16 outputs a drive signal to the hood actuator 22. At the same time, the airbag activation instruction unit 16 outputs an activation instruction signal for an inflator 21b to the airbag module 21.

The control unit 14 is coupled to various configuration units, for example, the airbag module 21 and the hood actuator 22 via an in-vehicle communication line such as a controller area network (CAN), for example.

Various configuration units other than the airbag module 21 and the hood actuator 22 illustrated in FIG. 1 are also coupled to the control unit 14. However, such configuration units are not directly related to the disclosure, and illustration and description thereof are thus omitted.

The airbag module 21 is a pedestrian protection mechanism including, for example, a pedestrian protection airbag (hereinafter, simply referred to as an airbag) 21a and the inflator 21b.

The airbag 21a is a configuration unit including a bag body that is inflated and deployed by gas at a position where the bag body covers a rigid portion (a lower portion of the windshield, lower portions of left and right front pillars (A pillars), a front cowling, a front wiper, and the like) in a front region of the host vehicle to prevent, for example, the head of a pedestrian or the like from direct impact on the rigid portion in the front region of the host vehicle. The inflator 21b is a gas generator for deploying the airbag 21a.

The hood actuator 22 is a drive mechanism having a function of, in response to receipt of an instruction signal from the airbag activation instruction unit 16, popping up an engine hood of the host vehicle at a predetermined time and assisting inflation and deployment of the airbag 21a.

As illustrated in FIG. 1, the control unit 14 is also coupled to various sensors such as the vehicle-mounted radar device 17, the vehicle-mounted LiDAR device 18, the collision detection sensor 19, and the vehicle speed sensor 20.

The vehicle-mounted radar device 17 includes, for example, a plurality of millimeter-wave radars and the like. The plurality of millimeter-wave radars receive reflected waves of radio waves output toward surroundings of the vehicle and reflected by and returning from surrounding objects, and analyze received waves that have been received, thereby detecting three-dimensional objects existing around the vehicle (for example, pedestrians and the like, other vehicles traveling alongside, and roadside structures (for example, curbstones, guardrails, walls of buildings or the like, and roadside vegetation)). In this case, the plurality of millimeter-wave radars detect, as specific information related to a three-dimensional object, the lateral width of the three-dimensional object, the position of a representative point of the three-dimensional object (the relative position and the relative distance with respect to the host vehicle), the relative speed, and the like.

A plurality of sensors (the plurality of millimeter-wave radars and the like) included in the vehicle-mounted radar device 17 include, for example, sensors disposed in left and right side portions of a front bumper (referred to as front left and right side sensors), and sensors disposed in left and right side portions of a rear bumper (referred to as rear left and right side sensors). The front left and right side sensors detect, as surrounding environment information, three-dimensional objects present in regions diagonally forward left and right and sideward of the host vehicle, which are difficult to recognize in images captured by the stereo camera 11. The rear left and right side sensors detect, as surrounding environment information, three-dimensional objects present in regions diagonally sideward left and right and rearward of the host vehicle, which are difficult to recognize with the front left and right side sensors.

As described above, the vehicle-mounted radar device 17 serves as a surrounding environment recognition device that recognizes a surrounding environment (a pedestrian or the like) around the vehicle. Information acquired by the vehicle-mounted radar device 17 is transmitted to the control unit 14.

The vehicle-mounted LiDAR device 18 is a laser sensor device that emits, for example, laser pulses to scan a predetermined range ahead, receives return pulses reflected and returning from a forward object within the predetermined range to acquire detailed three-dimensional point cloud data corresponding to the forward object included in the predetermined range in a forward region, and acquires three-dimensional point cloud data including accurate distance information.

As described above, the vehicle-mounted LiDAR device 18 serves as a surrounding environment recognition device that recognizes a surrounding environment (a pedestrian or the like) around the vehicle. Information acquired by the vehicle-mounted LiDAR device 18 is transmitted to the control unit 14.

The collision detection sensor 19 is a sensor mechanism that detects a collision between the host vehicle and a three-dimensional object (for example, a pedestrian or the like) present around the host vehicle. The collision detection sensor 19 includes, for example, a pressure sensor and the like. The collision detection sensor 19 is provided, for example, inside the front bumper, which extends in the vehicle width direction (left-right direction) at a front portion of the host vehicle. In this case, the collision detection sensor 19 is formed by a long pressure tube, a pressure chamber, or the like disposed along the front bumper.

For example, when a pedestrian or the like collides with the front bumper, the collision detection sensor 19 having such a configuration detects a collision input (a change in collision pressure) induced by crushing of the pressure tube, the pressure chamber, or the like.

The vehicle speed sensor 20 is a sensor that detects the vehicle speed of the host vehicle. A sensor generally put into practical use in a vehicle such as an automobile is used as the vehicle speed sensor 20.

The control unit 14 executes travel control of the vehicle based on various kinds of information acquired by the various sensors (i.e., the devices and sensors 17 to 20). The control unit 14 further executes control of the pedestrian protection device, as appropriate and necessary, based on surrounding environment information and the like recognized by the camera unit 10, the vehicle-mounted radar device 17, the vehicle-mounted LiDAR device 18, the collision detection sensor 19, the vehicle speed sensor 20, and the like.

All or some of the image recognition unit 13, the control unit 14, and the like are configured by a processor including hardware. The processor includes, for example, a known configuration including a central processing unit (CPU), a random access memory (RAM), a read only memory (ROM), a non-volatile memory, a non-volatile storage, a non-transitory computer readable medium, and the like, and peripheral devices thereof.

The ROM, the non-volatile memory, the non-volatile storage, and the like store in advance a software program executed by the CPU, fixed data such as a data table, and the like. The CPU reads the software program stored in the ROM or the like, loads the software program into the RAM, and executes the software program, and the software program appropriately refers to various data and the like. Accordingly, the respective functions of the above constituent parts and configuration units (the image recognition unit 13 and the control unit 14) and the like are implemented.

The processor may include a semiconductor chip such as a field programmable gate array (FPGA). The above constituent parts and configuration units (the image recognition unit 13 and the control unit 14) and the like may be configured by electronic circuits.

Further, all or part of the software program may be recorded as a computer program product on a portable disk medium such as a flexible disk, a CD-ROM, or a DVD-ROM, a non-transitory computer readable medium such as a card-type memory, a hard disk drive (HDD) device, or a solid state drive (SSD) device, or the like.

Although not illustrated in the drawings, a host vehicle provided with the vehicle control device 1 including the pedestrian protection device of the present embodiment is assumed to be a vehicle of a general type as follows.

The host vehicle includes an engine room provided at the front portion of the vehicle body thereof. The front bumper extending in the vehicle width direction (left-right direction) is disposed at a front portion of the engine room.

An upper portion of the engine room is covered by an engine hood so as to be openable and closable. The airbag module 21 serving as a pedestrian protection mechanism is disposed on an inner surface of the engine hood.

The engine hood is, for example, a front-opening hood. Thus, hood hinges are provided at the rear edge of the engine hood near both sides in the vehicle width direction. The engine hood is configured to be openable and closable with the hood hinges as fulcrums. The hood hinges are provided with the hood actuator 22.

As described above, the hood actuator 22 is a drive mechanism that, in response to receipt of an instruction signal from the airbag activation instruction unit 16, pops up the engine hood at a predetermined time.

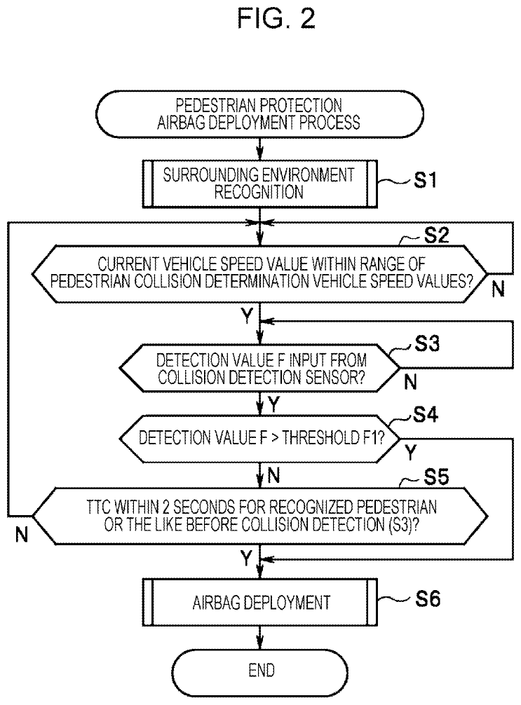

The operation of the vehicle control device 1 including the pedestrian protection device of the present embodiment configured as described above will be briefly described below. FIG. 2 is a flowchart illustrating the operation of the vehicle control device 1 including the pedestrian protection device of the present embodiment.

First, it is assumed that the host vehicle (not illustrated) provided with the vehicle control device 1 including the pedestrian protection device is in an activated state in which the host vehicle can travel on a road, for example. At this time, the vehicle control device 1 is also in an activated state.

In step S1, in response to receipt of sensor inputs from the camera unit 10 and the various sensors (the devices and sensors 17, 18, 19, and 20 and the like), the control unit 14 executes a surrounding environment recognition process for recognizing an environment around the host vehicle. The surrounding environment recognition process is continuously executed while the host vehicle is in the activated state.

In the present embodiment, the surrounding environment recognition process executed in step S1 also includes the following processing.

First, the control unit 14 continuously detects a vehicle speed value of the host vehicle sequentially at predetermined time intervals, based on a detection value from the vehicle speed sensor 20. The detection result (vehicle speed value) is temporarily recorded for a predetermined period of time. The detection result is temporarily recorded using, for example, a buffer memory (not illustrated) included in the control unit 14.

Second, the image recognition unit 13 of the camera unit 10 recognizes a pedestrian or the like in image recognition processing. At the same time, the control unit 14 calculates a time to collision (TTC) for the pedestrian or the like recognized by the image recognition unit 13.

The TTC is calculated based on distance information indicating the distance from the host vehicle to a target pedestrian or the like that has been recognized and the vehicle speed value of the host vehicle at the time when the target pedestrian or the like is recognized.

As a result of the TTC calculation process, if the TTC calculated for the recognized pedestrian or the like is within a predetermined number of seconds (for example, 2 seconds), the corresponding data (recognition data of the pedestrian or the like and the TTC value) are temporarily recorded in the buffer memory or the like. The numerical value of 2 seconds for the TTC is merely exemplary. Thus, the numerical value used as a condition is not limited to the exemplary numerical value and is appropriately set as necessary.

In step S2, the control unit 14 checks whether the current vehicle speed value of the host vehicle is within a predetermined range of pedestrian collision determination vehicle speed values (for example, 25 to 60 km/h). In this case, the vehicle speed value of the host vehicle is obtained by referring to a value detected in step S1 described above based on the detection value from the vehicle speed sensor 20.

If it is confirmed in the processing of step S2 that the current vehicle speed value of the host vehicle is within the predetermined range of pedestrian collision determination vehicle speed values, the process proceeds to step S3. If the current vehicle speed value of the host vehicle is outside the predetermined range of pedestrian collision determination vehicle speed values, this checking process is repeated.

In step S3, the control unit 14 checks whether a detection value F is input from the collision detection sensor 19. If an input (detection value F) from the collision detection sensor 19 is confirmed, the process proceeds to step S4. If an input (detection value F) from the collision detection sensor 19 is not confirmed, this confirmation processing is repeated.

Subsequently, in step S4, the control unit 14 checks whether the input (detection value F) from the collision detection sensor 19 exceeds a predetermined threshold F1 set in advance (a predetermined value for a so-called light collision). If it is confirmed that the detection value F is greater than the threshold F1, the process proceeds to step S6. If the detection value F is not greater than the threshold F1, the process proceeds to step S5.

In step S5, the control unit 14 refers to the buffer memory or the like and checks whether data indicating that the TTC for the recognized pedestrian or the like is within the predetermined number of seconds (for example, 2 seconds) is present within a predetermined amount of time (for example, about 2 seconds) before the processing of step S3 (collision detection). If it is confirmed that data indicating that the TTC for the recognized pedestrian or the like is within the predetermined number of seconds (for example, 2 seconds) is present, the process proceeds to step S6. If data indicating that the TTC for the recognized pedestrian or the like is within the predetermined number of seconds (for example, 2 seconds) is not present, the process returns to step S2, and the subsequent processing is repeated.

In step S6, the control unit 14 outputs a predetermined instruction signal from the airbag activation instruction unit 16 and executes a predetermined airbag deployment process. The airbag deployment process performed here is a process for deploying the airbag 21a. This airbag deployment process is substantially the same as a pedestrian protection airbag deployment process by a conventional pedestrian protection device, and is generally as follows.

The airbag deployment process executed in the processing of step S6 starts in response to a predetermined instruction signal being output from the airbag activation instruction unit 16 of the control unit 14.

First, the airbag activation instruction unit 16 outputs a predetermined drive signal to the hood actuator 22. At the same time, the airbag activation instruction unit 16 outputs an activation instruction signal for the inflator 21b to the airbag module 21.

In response to receipt of the drive signal, the hood actuator 22 pops up the rear edge of the engine hood. When the rear edge of the engine hood is popped up in this way, a gap opening is generated between the engine hood and the engine room.

On the other hand, the airbag module 21 activates the inflator 21b in response to receipt of the activation instruction signal. When the inflator 21b is activated in this way, the airbag 21a inflates and deploys.

At this time, the airbag 21a inflates and deploys while expanding from the inner surface of the engine hood through the generated gap opening toward the left and right edges and the lower portion of the windshield. As a result, the airbag 21a is disposed at a position where the airbag 21a covers the rigid portion (the lower portion of the windshield, the lower portions of the left and right front pillars (A-pillars), the front cowling, the front wiper, and the like) in the front region of the host vehicle. Accordingly, the airbag 21a prevents the head of a pedestrian or the like from direct impact on the rigid portion in the front region of the host vehicle.

As described above, according to the above-described embodiment, in a normal case, the pedestrian collision determiner 15 determines that the host vehicle has collided with a pedestrian or the like when:
(1) the current vehicle speed value of the host vehicle is within a predetermined range of pedestrian collision determination vehicle speed values; and
(2) the detection value F of the collision detection sensor 19 exceeds the predetermined threshold F1 (F>F1).

The pedestrian collision determiner 15 also determines that the host vehicle has collided with a pedestrian or the like in the following case.

Even when the detection value F of the collision detection sensor 19 is equal to or less than the predetermined threshold F1 (F1≥F), if a predetermined condition (3) is also satisfied in addition to the condition (1) above, the pedestrian collision determiner 15 determines that the host vehicle has collided with a pedestrian or the like.

The predetermined condition (3) is as follows:
(3) When the camera unit 10 recognizes a pedestrian or the like within a predetermined amount of time (for example, about 2 seconds) before the point in time when collision detection is made by the collision detection sensor 19, and the TTC for the pedestrian or the like is within a predetermined number of seconds (for example, 2 seconds).

This configuration allows the pedestrian protection device of the present embodiment to reliably deploy the pedestrian protection airbag in response to the host vehicle colliding with a pedestrian or the like, even when the collision with the pedestrian or the like is not clearly identifiable based only on the detection value of the collision detection sensor 19 due to some reason such as, for example, the body size or posture of the pedestrian or the traveling state of the host vehicle. Therefore, it is possible to contribute to reduction of collision damage to the pedestrian or the like.

It is to be understood that the disclosure is not limited to the embodiment described above and various modifications and applications may be made without departing from the scope of the disclosure. Furthermore, the above-described embodiment includes various aspects of the disclosure, and various aspects of the disclosure may be derived by any appropriate combinations of the constituent elements disclosed herein. For example, some of the constituent elements in the above-described embodiment may be omitted as long as the problems to be addressed by the disclosure can be addressed and the effects of the disclosure can be achieved. Furthermore, constituent elements across different embodiments may be appropriately combined. The disclosure is not restricted to specific embodiments thereof except as defined by the appended claims.

According to an embodiment of the disclosure, it is possible to provide a pedestrian protection device capable of ensuring reliable operation of a pedestrian protection mechanism to protect a pedestrian or the like more reliably, or capable of reducing collision damage to a pedestrian or the like.

The control unit 14 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control unit 14 including the pedestrian collision determiner 15 and the airbag activation instruction unit 16. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A pedestrian protection device for a vehicle, the pedestrian protection device being configured to operate a pedestrian protection mechanism in response to a collision input to a collision detection sensor, the pedestrian protection device comprising:
a surrounding environment recognition device configured to acquire surrounding environment information of the vehicle;
a vehicle speed sensor configured to detect a speed of the vehicle;
the collision detection sensor configured to detect a collision between the vehicle and a three-dimensional object present around the vehicle;
the pedestrian protection mechanism comprising:
a pedestrian protection airbag; and
an inflator; and
a control unit comprising:
a pedestrian collision determiner configured to perform a determination on whether a collision of a pedestrian with the vehicle has occurred, based on an output of the surrounding environment recognition device, an output of the vehicle speed sensor, and an output of the collision detection sensor; and
an airbag activation instruction unit configured to output an instruction signal for activating the pedestrian protection mechanism based on the determination of the pedestrian collision determiner, wherein
the control unit is configured to calculate, based on the output of the surrounding environment recognition device and the output of the vehicle speed sensor, a time to collision for a recognized pedestrian, and
when the time to collision for the recognized pedestrian is within a predetermined number of seconds and the recognized pedestrian is recognized before the collision input to the collision detection sensor is detected, the pedestrian collision determiner is configured to determine that the vehicle has collided with the recognized pedestrian even in a case where
a vehicle speed value detected by the vehicle speed sensor is within a predetermined range of pedestrian collision determination vehicle speed values, and
a detection value obtained by the collision detection sensor does not exceed a predetermined threshold.

2. The pedestrian protection device according to claim 1, wherein
the collision detection sensor comprises a pressure tube or a pressure chamber provided inside a front bumper of the vehicle and is configured to detect a change in collision pressure.

3. The pedestrian protection device according to claim 1, wherein the surrounding environment recognition device comprises:
a stereo camera unit configured to acquire stereo image data; and
an image recognition unit configured to:
recognize the pedestrian from among three-dimensional objects imaged within an imaging region of the stereo camera unit, based on the stereo image data acquired by the stereo camera unit; and
acquire distance information indicating a distance from the vehicle to the recognized pedestrian.

4. The pedestrian protection device according to claim 3, wherein the surrounding environment recognition device further comprises a vehicle-mounted radar device or a vehicle-mounted light detection and ranging device.

5. A pedestrian protection device for a vehicle, the pedestrian protection device being configured to operate a pedestrian protection mechanism in response to a collision input to a collision detection sensor, the pedestrian protection device comprising:
a surrounding environment recognition device comprising a camera and configured to acquire surrounding environment information of the vehicle;
a vehicle speed sensor configured to detect a speed of the vehicle;
the collision detection sensor configured to detect a collision between the vehicle and a three-dimensional object present around the vehicle;
the pedestrian protection mechanism comprising:
a pedestrian protection airbag; and
an inflator; and
circuitry configured to:
perform a determination on whether a collision of a pedestrian with the vehicle has occurred, based on an output of the surrounding environment recognition device, an output of the vehicle speed sensor, and an output of the collision detection sensor;
output an instruction signal for activating the pedestrian protection mechanism based on the determination;
calculate, based on the output of the surrounding environment recognition device and the output of the vehicle speed sensor, a time to collision for a recognized pedestrian; and
when the time to collision for the recognized pedestrian is within a predetermined number of seconds and the recognized pedestrian is recognized before the collision input to the collision detection sensor is detected, determine that the vehicle has collided with the recognized pedestrian even in a case where
a vehicle speed value detected by the vehicle speed sensor is within a predetermined range of pedestrian collision determination vehicle speed values, and
a detection value obtained by the collision detection sensor does not exceed a predetermined threshold.
